(19) United States
(12) Patent Application Publication
(10) Pub. No.: US 2005/0235796 A1
(43) Pub. Date: Oct. 27, 2005

(54) Apparatus and method for making articles from flat stock material

(76) Inventors: Steven F. Willits, Barrington, IL (US); Samuel P. Willits, Barrington, IL (US)

Correspondence Address: ROBERT A. BROWN, P. O. BOX 2127, NORTHBROOK, IL, 60065-2127, US

(21) Appl. No.: 10/832,015

(22) Filed: Apr. 26, 2004

(51) Int. Cl. B26D 3/00

(52) U.S. Cl. 83/623; 83/627

(57) ABSTRACT

An apparatus and method for making articles using a pair of flat, mirror imaged, cutting dies formed by etching, machining, welding or a combination thereof, disposed opposite each other and having cutting knives facing each other. The dies are mounted in a flat die set and driven by a reciprocating flat-bed press which controls their spatial relationship to cut and score articles from flat stock sheets or other material adaptable to be paid out from cylindrical storage rolls.

### BACKGROUND OF THE INVENTION

The present invention relates generally to an apparatus and method for blanking articles, such as cards, from flat stock sheets and roll material to achieve a desired size control, edge smoothness and break-off characteristics required by purveyors of plastic cards, such as consumer retail establishments, department and grocery stores, banks, and the like. The present invention relates more particularly to an apparatus including formed cutting dies, disposed opposite each other having cutting edges driven by a reciprocating punch press to partially and/or completely cut out articles from flat stock.

In the past, making articles from various types of flat stock material has required long lead times, complex and costly male/female blanking tools. Also, known methods often necessitate multiple operative steps to achieve the required card characteristics specified by a client. In the present day economic climate, customers demand more varied external and internal shapes. Card production runs are shorter and must now be finished in lesser periods of time.

A lower cost method to produce quality cards would be welcomed by card manufacturers and card sellers. The card making apparatus and method described herein employs low-cost die technology using dies formed by etching, welding, machining or a combination thereof in a new and inventive manner to produce a wide variety of articles, cards, and the like, usually in a single operation through a die cutting station. Illustrative of prior art unsuccessful attempts to solve the aforesaid problems are shown in U.S. Pat. No. 4,294,649 to Sarka; U.S. Pat. No. 5,417,132 to Cox et al; U.S. Pat. No. 5,488,889 to Kang; U.S. Pat. No. 5,575,185 to Cox et al; and U.S. Pat. No. 6,311,601 to Love.

### SUMMARY OF THE INVENTION

Therefore, it is a primary object of the present invention to provide an improved apparatus and method for making articles that include a machine constructed to use a first and second die holder operable to move relative to each other and containing interchangeable dies for cutting configured articles from flat stock material that may include embossed flat stock material.

It is a further object of the present invention to provide an improved apparatus and method for making articles or goods that include feeding flat stock material into a machine and having selected dies partially impress design configurations into the material for subsequent bending and breaking apart.

Another object of the present invention is to provide an improved apparatus and method for making articles that includes feeding flat stock material into a machine having selected dies for cutting therethrough and subsequent removal therefrom a designed configuration.

An additional object of the present invention is to provide an improved apparatus and method for making articles that includes interchangeable dies having closed loop configurations and internal contoured patterns for both complete and partial cutting of selectively designed cards from flat stock material.

A reciprocating punch press is fitted with a die set comprising flat and parallel top and bottom shoes, mechanical devices for registering and holding interchangeable dies, posts and stops for controlling the spatial relationship between the die shoes. The die set may have standoffs to isolate the die shoes from outside forces. Mirror image dies are registered and secured to the die shoes such that their cutting knives face and precisely align with each other, knife point to knife point. The cutting knifes can be formed by etching, welding, machining or a combination thereof. The formed knifes may have symmetrical straight sides, asymmetrical straight sides, or sides formed by double bevels. The apex may be formed of a larger included angle than the base of the cutting knife. The mirror image dies consist of at least one closed loop shape but may provide any number of other closed-loop shape configurations. The mirror image dies may have cutting knives outside any closed-loop shape configuration and not forming a closed-loop shape, which may or may not be mirrored on the opposed die of the pair. Each closed loop shape may have cutting edges within its perimeter which are themselves closed or not closed-loop shapes, which cutting edges may be a different height and formed of a different included cutting angle than the cutting edge in whose perimeter it resides. A sheet or roll of flat stock material is placed between the dies and the press cycled once such that the opposed knife points close to within 0.005″ or less, one to the other. The cutting knife may be made to a height less than or just slightly more than half the sheet thickness, to thereby control penetration depth of the knives into the sheet from both sides of the sheet. In the case of embossed material the knives on one side may be formed longer than the knives on the other side to allow proper penetration from both sides of the sheet. When the knives move close to each other, the sheet, if made from a sufficiently dense and brittle material such as PVC or Polycarbonate, fractures due to the stresses imposed on it by the closing knives. When the knives form a closed-loop shape and the sheet fractures along this configured shape an article such as a card is cut from the sheet. Cutting knives inside of the closed-loop shape having a lesser height than the closed-loop shape may be used to make surface score cuts on either or both surfaces of the sheet to thereby weaken the material so that the scored pieces may be broken apart in a subsequent step. Additional closed-loop shapes within the closed-loop shape may have a cutting edge of height equal to the closed-loop shape so that these additional shapes fracture the material and produce holes or slots or unique shapes internal to the closed-loop shape. Additional cutting knives outside any closed loop shape may be used to score the surface of the sheet to thereby weaken the flat stock and make it more pliable for subsequent operations such as extraction of the cut parts from the sheet. An automatic registration feed machine, such as disclosed in Willits, et al, U.S. Pat. No. 4,809,188, may be used to position decorated sheets in the die set such that the knives cut the sheet relative to the sheet decoration, thereby producing parts such as cards, puzzles and ornaments from sheet material whose graphics match the closed-loop configuration of the dies.

### BRIEF DESCRIPTION OF THE DRAWING

The foregoing and other characteristics, objects, features and advantages of the present invention will become more apparent upon consideration of the following detailed description, having reference to the accompanying figures of the drawing, wherein:

FIG. 1 illustrates a front elevational view of the apparatus of the present invention comprising a press, first and second die holders to which are mounted opposed dies, guide posts, pins for mechanically registering the dies, stop members between top and bottom die shoes to control separation of the shoes, load distributing elements to isolate forces, a bolster plate, a sheet of flat stock material located between the dies and driven by an opto-mechanical positioning device.

FIG. 2 shows a side elevational view of the apparatus of FIG. 1.

FIG. 3 is a sectional view of the apparatus shown in FIG. 1 taken along line 3-3 thereof.

FIG. 4 illustrates a perspective view of a set of opposed, mirror image dies forming a simple, closed loop shape, the dies removed from the die holder but in the same orientation as when mounted in the die holder.

FIG. 5 shows a frontal view of the set of dies shown in FIG. 4.

FIG. 6 is a sectional view of the dies taken along line 6-6 of FIG. 5.

FIG. 7 is a plan view of a die forming a simple closed-loop shape.

FIG. 8 is a sectional view of the die taken along line 8-8 of FIG. 7.

FIG. 9 is an enlarged sectional view of a portion of the die shown in FIG. 8, taken along circular line 9 thereof.

FIG. 10a is a plan view of a set of dies having the same shape as the dies illustrated in FIG. 4.

FIG. 10b is a cross-section view of the dies shown in FIG. 10a, taken along line 10b-10b thereof.

FIG. 10c is an enlarged cross section view of the dies of FIG. 10b taken along circular line 10C thereof, in a near closed position with a sheet of material between them, showing the knives of the opposed dies partially penetrating into the top and bottom surfaces of the sheet of material.

FIG. 11a is a plan view of the dies shown in FIG. 10a.

FIG. 11b is a cross-section view of the dies illustrated in FIG. 11a, taken along line 11b-11b thereof, showing the knives of the opposed dies in a closed position after having penetrated and cut through the material.

FIG. 11c is an enlarged cross section view of the dies of FIG. 11b, taken along circular line 11c thereof, in a closed position with a sheet of material between them, showing the knives of the opposed dies completely cutting through the top and bottom surfaces of the sheet of material.

FIG. 12 is an isometric view of one of a pair of opposed, mirror image dies forming an irregular closed loop shape.

FIG. 13 is an isometric view illustrating one of a pair of opposed, mirror image dies forming a simple closed loop shape surrounding an internal knife, the internal knife having a lesser cutting height than the outer closed loop shape.

FIG. 14 is a plan view the die shown in FIG. 13.

FIG. 15 depicts a cross-section view of the die of FIGS. 13-14 taken along line 15-15 of FIG. 14.

FIG. 16 illustrates a plan view of a pair of dies one of which is shown in FIGS. 13-15.

FIG. 17 is a cross-section view of the dies of FIG. 16 taken along line 17-17 thereof.

FIG. 18 is an enlarged cross-section view of the dies illustrated in FIG. 17 taken along the circular line 18.

FIG. 19 is an isometric illustration of one of a pair of opposed, mirror image dies forming a closed loop shape, surrounding internal knife of equal cutting height to the perimeter.

FIG. 20 is a plan view of a mirror image set of the dies illustrated in FIG. 18.

FIG. 21 is a cross-section view of the dies illustrated in FIG. 20 taken along line 21-21 thereof, in a closed cutting position with a sheet of material cut through at the perimeter closed loop shape and also cut through at the internal knives of equal cutting height to the perimeter.

FIG. 22 is an enlarged cross-section view of the dies shown in FIG. 21 taken along circular line 22 thereof, showing in greater detail complete cutting of the sheet material.

FIG. 23 is a plan view of a set of opposed, mirror image dies forming a closed loop shape, whereon the knives internal to the closed loop shape on one plate are of a different height than the knives internal to the closed loop shape on its opposed plate.

FIG. 24 is a cross-section view of the dies shown in FIG. 23 taken along line 24-24 thereof.

FIG. 25 is a plan view of a set of opposed, mirror image dies forming a closed loop shape, whereon internal cutting knives are located on only one of the dies.

FIG. 26 is a cross-section view of the dies shown in FIG. 25 taken along line 26-26 thereof.

FIG. 27 illustrates an isometric view of one of a pair of opposed, mirror image dies forming multiple closed loop shapes.

FIG. 28 shows a plan view of the opposed pair of the dies illustrated in FIG. 27.

FIG. 29 illustrates in cross-section the dies shown in FIGS. 27-28 taken along line 29-29 of FIG. 28.

FIG. 30 shows an expanded elevational view of the die rule measurement height just slightly more than half the thickness of the flat stock material.

FIG. 31 is a plan view of a portion of a die shoe showing one of a set of adjustable stop members that accurately control the minimum separation dimension between the die shoes.

FIG. 32 shows a cross-section view of the adjustable stop member of FIG. 31 taken along line 32-32 thereof.

FIG. 33 is an isometric view of a length of a decorated sheet of material.

FIG. 34 is an enlarged isometric view of a portion of the decorated sheet of material shown in FIG. 33 taken along circular line 34 thereof.

FIG. 35 illustrates an isometric view of decorated material as paid out from a storage roll cylinder.

FIG. 36 is an enlarged isometric view of a portion of the decorated sheet of material shown in FIG. 35 taken along circular line 36 thereof.

FIG. 37 is a plan view of one die having rule of a non-closed loop configuration outside any closed loop configuration.

FIG. 38 is a cross-sectional view taken along line 38-38 of the die illustrated in FIG. 37.

FIG. 39 is a profile view of a double-bevel cutting knife.

FIG. 40 is a profile view of an asymmetrical cutting knife.

FIG. 41 is a profile view of an asymmetrical, multi-bevel cutting knife.

### DESCRIPTION OF A PREFERRED EMBODIMENT

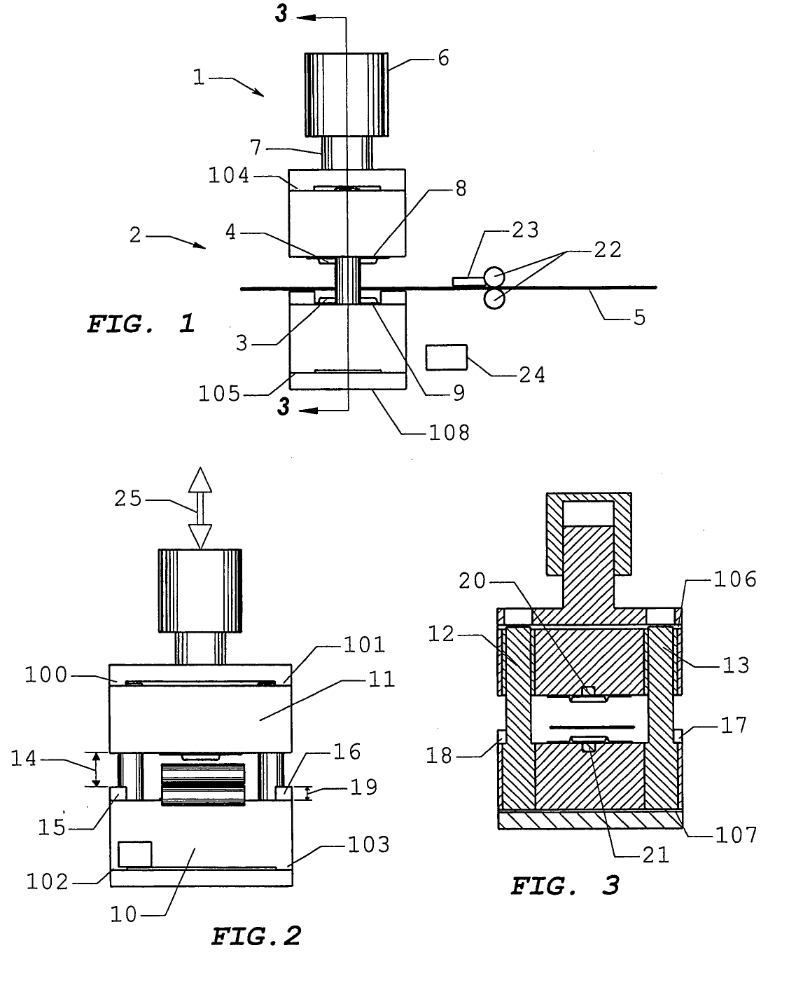

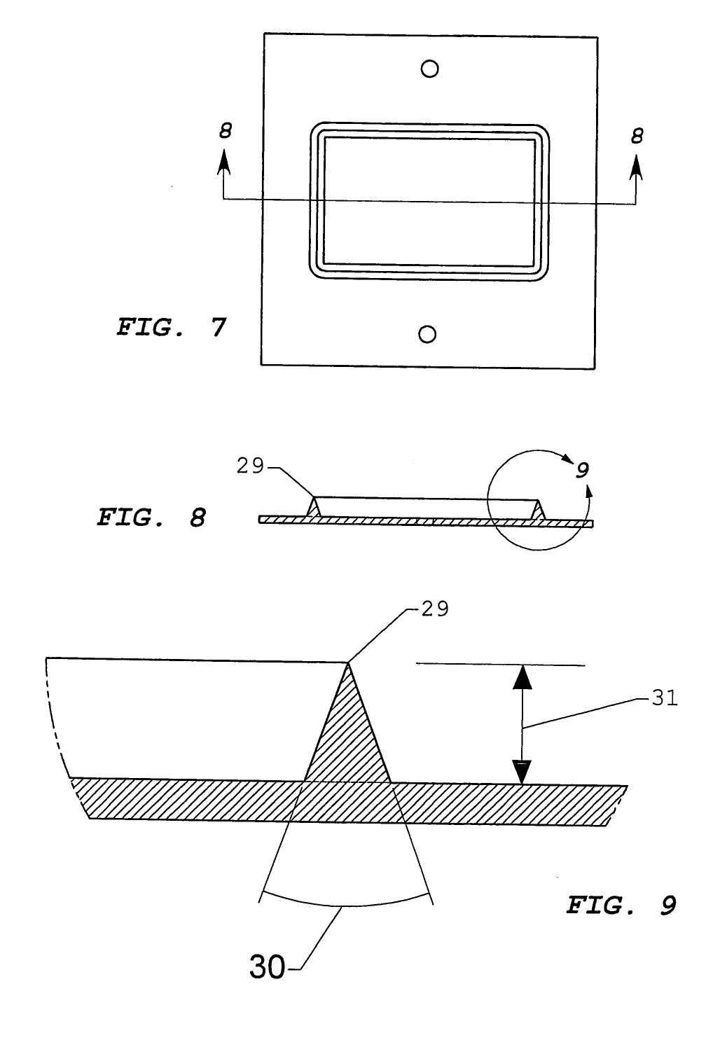

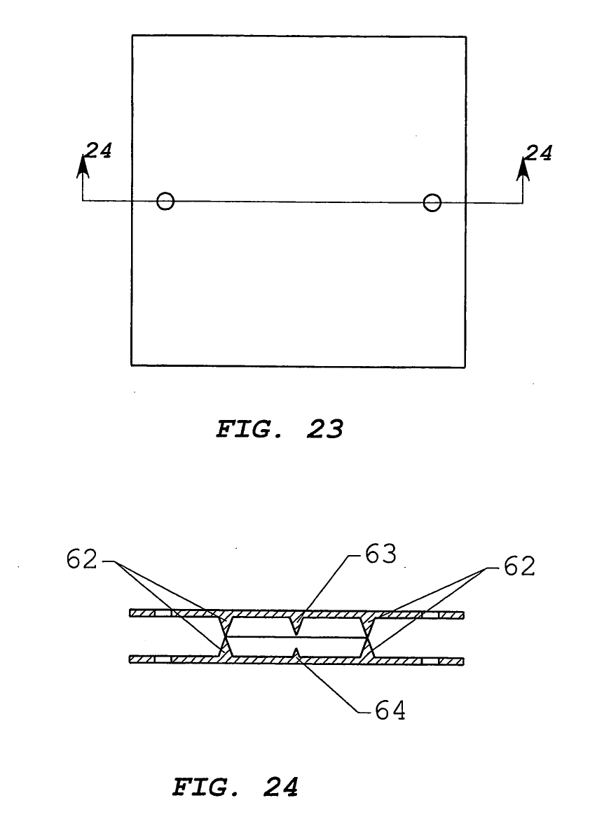

Referring now to FIGS. 1-41, there is shown in greater detail an improved apparatus for making articles from flat stock material including a press, generally indicated in FIG. 1 by reference numeral 1. The apparatus also includes a die set, generally identified by reference numeral 2, formed dies 3 and 4, and material 5. Apparatus 1 comprises a press ram cylinder 6, which drives piston 7 in a reciprocating motion along path 25, FIG. 2, normal to parallel surfaces 8 and 9. In this illustrated embodiment, a bottom die holder or anvil 10 remains stationary, supported through standoffs 102, 103, 105 and 107 by bolster plate 108, which is rigidly connected to ram cylinder 6 by a structure not shown, while an upper die holder or striker 11, guided by die guide posts 12 and 13, FIG. 3, and driven by piston ram cylinder 6 operating piston 7, moves along path 25 to change distance 14. Stop members 15, 16, 17 and 18 control the minimum distance 19 to which surfaces 8 and 9 can approach one to the other. Press forces are directed to striker 11 through standoffs 100, 101, 104 and 106. Die 3 is pin registered on surface 9 and secured with a magnet 21. Die 4 is pin registered on surface 8, and secured with a magnet 20. Material 5 is positioned between dies 3 and 4 parallel to surfaces 8 and 9 by driven nip rollers 22 with a sensor 23 and a controller 24 comprising the control system for driven nip rollers 22.

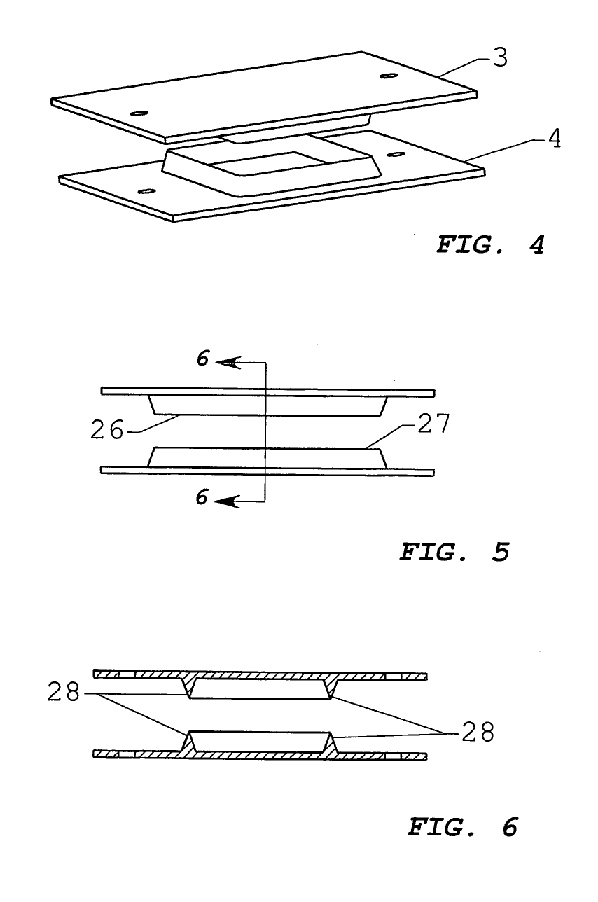

Next referring to FIG. 4, dies 3 and 4 are shown in the same orientation as in FIG. 1, but with the surrounding elements removed for greater clarity. A cutting edge 26, FIG. 5, forms a closed loop shape on die 3 and a mirror image of cutting edge 26 forms a closed loop shape 27 on die 4. Cutting edges 26 and 27 face one to the other with their respective closed loop shapes oriented collinearly along the axis of path 25 (see FIG. 2) such that if distance 14 shown in FIG. 2 were decreased, cutting edges 26 and 27 would exactly meet at their apexes 28, FIG. 6.

As best shown in FIGS. 8 and 9, there is depicted a cross sectional view of a triangularly shaped cutting knife 29, typical of the cutting knives on dies 3 and 4. An apex angle 30 of the cutting knife 29 is sharpened to between sharp and 0.005 inch flat. The sharpened knife can be formed by etching, welding, machining or a combination thereof. The formed knife may have symmetrical straight sides, asymmetrical straight sides, or sides formed by double bevels, with for example the apex having a larger included angle than the base of the cutting knife. The angle 30 ranges between thirty and seventy-five degrees at the apex. A vertex height 31 of the cutting knife 29 measures between 0.005 inch and 0.060 inch.

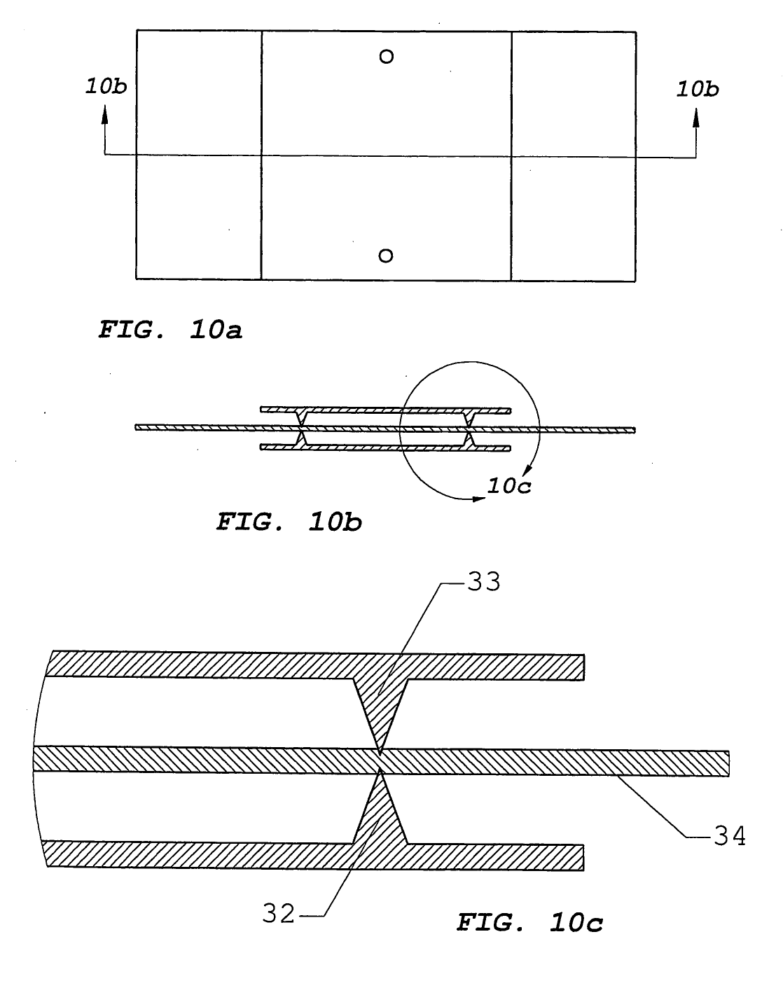

In FIGS. 10a, 10b and 10c there is illustrated a cross sectional view of triangular shaped cutting knifes 32 and 33 pressed into and partially penetrating material 34.

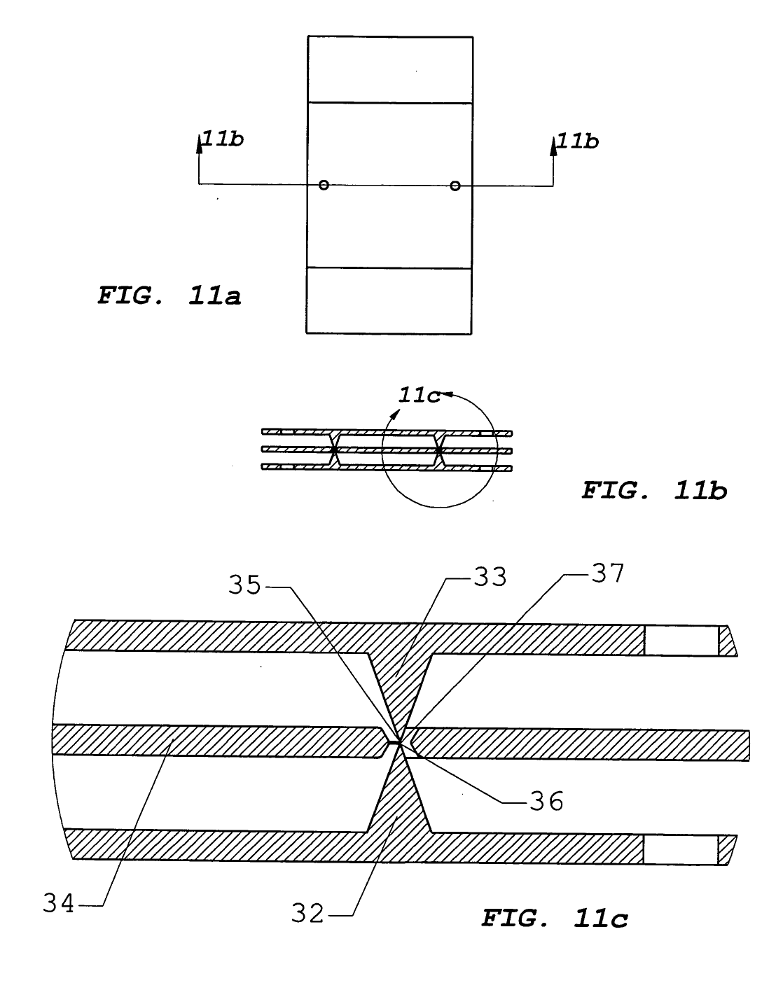

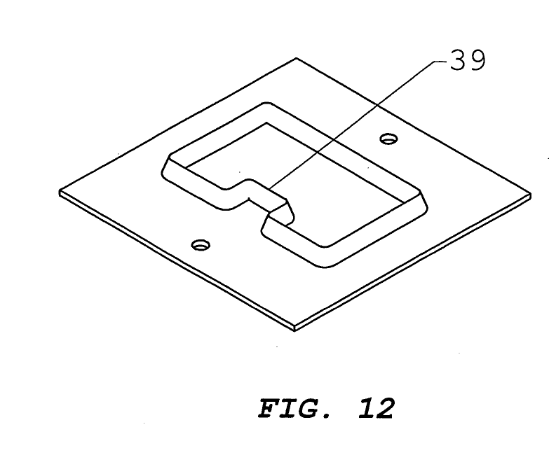

Illustrated in FIGS. 11a, 11b and 11c, and as best seen in FIG. 11c, is a cross sectional view of triangular shaped cutting knifes 33 and 32 penetrated into material 34 such that apexes 35 and 36 nearly contact each other, which action has stressed material 34 to fracture at line 37 essentially collinear to the meeting points of cutting knife apexes 35 and 36.

FIG. 12 depicts an isometric view of one of a pair of dies forming an irregular, closed-loop shape 39. A multitude of perimeter closed loop shapes can be employed to cut articles of many shapes and sizes from flat stock material.

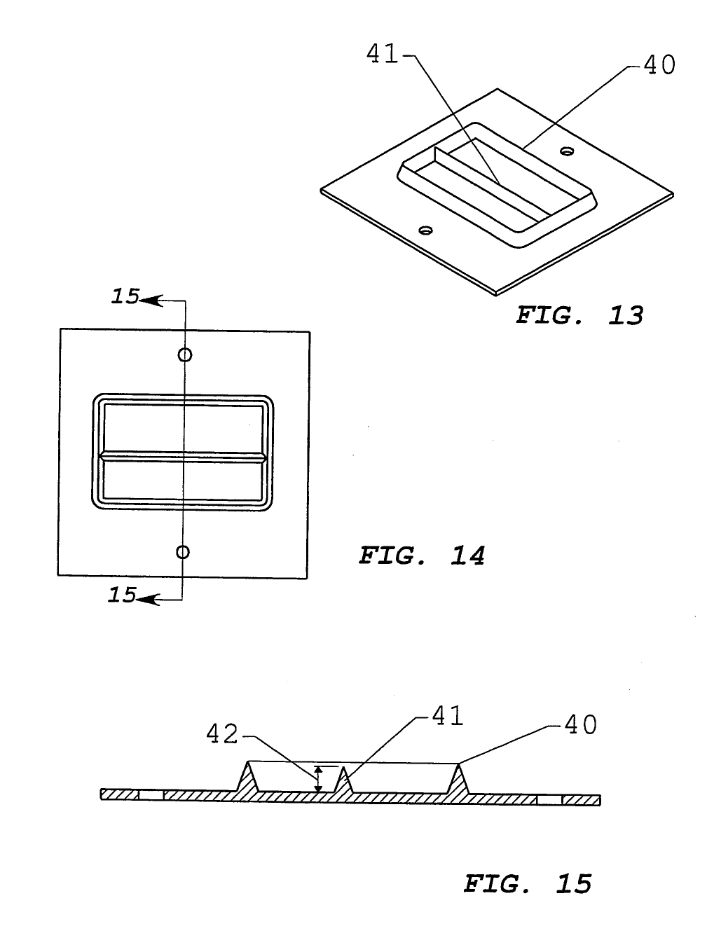

Illustrated in FIGS. 13 and 15 are isometric and cross sectional views of one of a pair of cutting dies having a closed loop perimeter 40 surrounding a rule or cutting edge 41 interior to the closed loop perimeter 40 having a lesser height 42 than that of the closed loop shape. Rule, or cutting edge 41 does not cut as deeply into the material as perimeter rule 40, thereby making only a partial or score cut in the material interior to the perimeter of the cut shape.

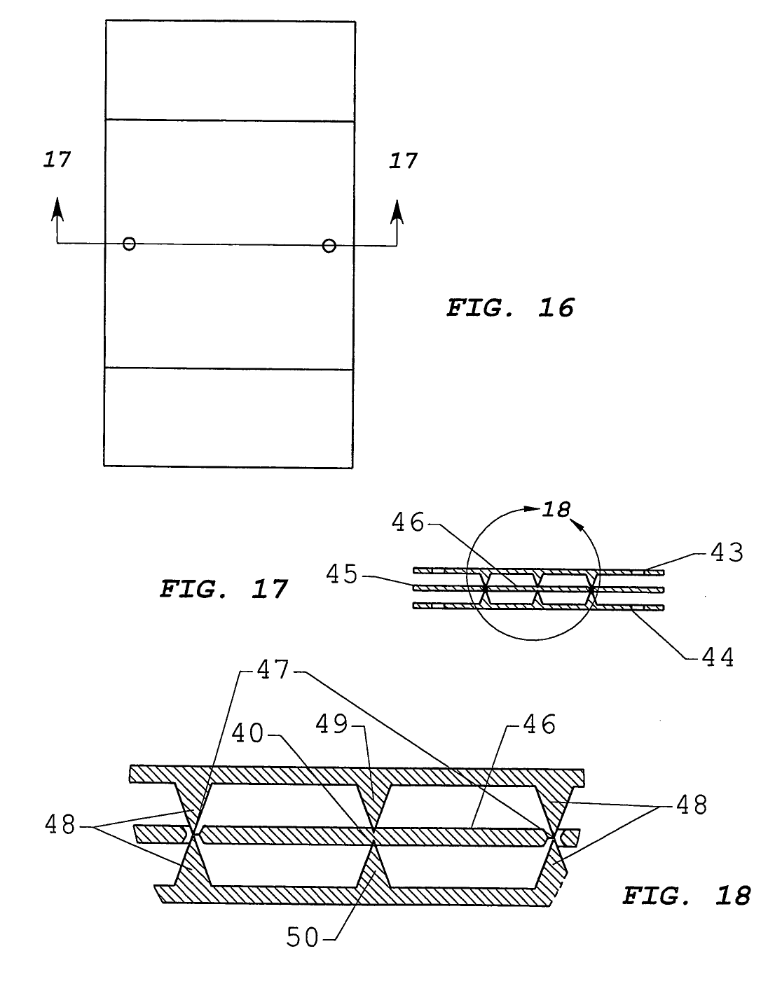

FIG. 17 illustrates the die 43 shown in FIG. 16 along with its co-die 44 oriented in each respective cutting position with material 45 between them.

FIG. 18 illustrates card 46 shown in plan view in FIG. 14, which has been formed by the fracture of material 45 along line 47 collinear with the closed loop perimeter shape formed by cutting knives 48; and lesser height cutting knives 49 and 50 have score cut into material 45 interior to the closed loop shape.

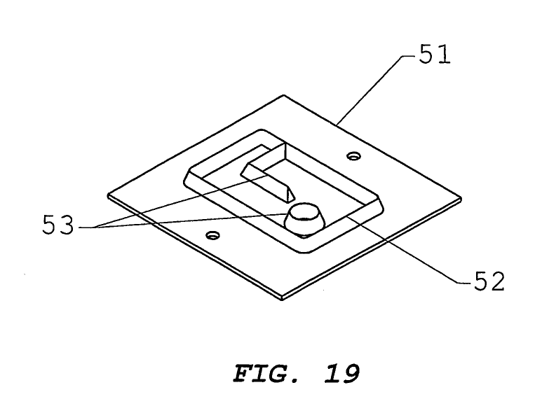

Illustrated in the isometric view of FIG. 19 is one of a pair of cutting dies 51 having a closed loop perimeter 52 surrounding interior cutting knives 53 of a height equal to cutting knife 52.

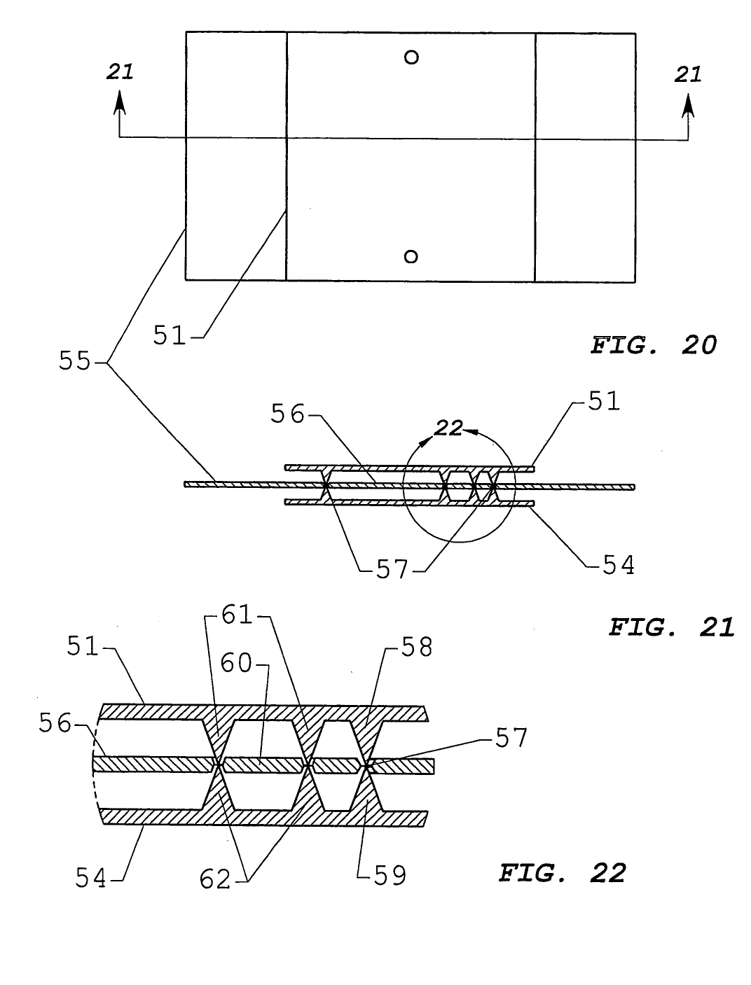

FIG. 21 illustrates in cross section the die 51 shown in FIG. 20 along with its co-die 54 oriented in a respective cutting position with material 55 between them. Card 56 has been formed by the fracture of material 55 along line 57 collinear with the closed loop perimeter shape formed by cutting knives 58 and 59, as shown in the detail cross section illustrated in FIG. 22. Interior circular shape 60 has been formed from material 55 by opposed interior cutting rules of equal cutting height 61 and 62. Although not illustrated here, the “L” shaped section of cutting knife 53 shown in FIG. 19 along with its mirror image cutting knife, will also cut through material 55 along the line of its cutting edge, leaving a slit “L” shape in Card 56.

FIG. 24 illustrates a section view of a pair of cutting dies 62 having a closed loop perimeter surrounding interior cutting knifes 63 and 64 which are of similar shapes but of unequal heights. This embodiment produces cards with score cuts where one side is cut deeper than its opposite side. This can be useful to cut through laminated construction material to penetrate to the center of the material without fracturing the material.

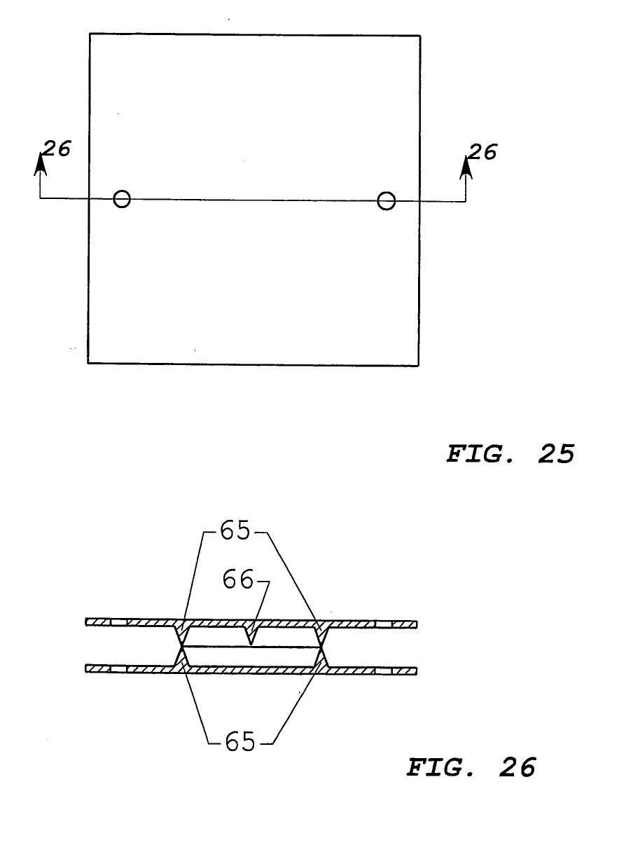

FIG. 26 illustrates a section view of a pair of cutting dies 65 having a closed loop perimeter surrounding interior cutting knife 66 which is disposed only on one of the cutting dies and has no opposing cutting rule. This produces a score cut on only one side of a piece fractured by the closing of closed loop perimeter 65.

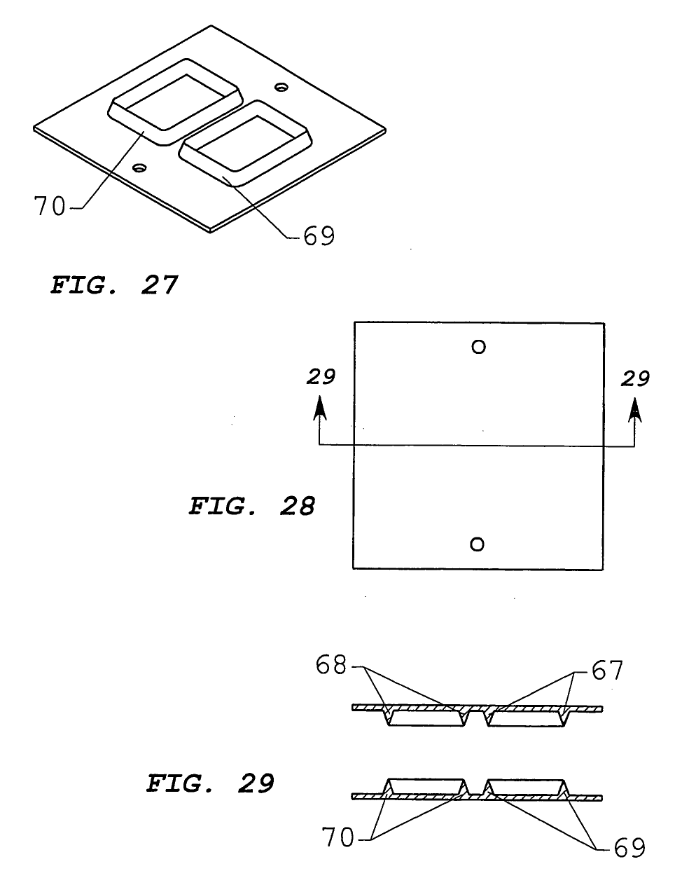

FIGS. 27-29 illustrate a pair of cutting dies with knives 67, 68, 69 and 70 forming more than one closed loop shape, 67 and 68 on the upper die, and 69 and 70 on its opposed mirror image lower die, which shapes are not surrounded by another closed loop shape. The illustrated closed loop shapes are rectangular, identical in shape and size and would produce two cards of identical shape and size with each cycle of press 1. In the operation of this embodiment, the cutting knife edge configurations on one pair of dies may be entirely different from the configured shapes and sizes of any other pair of dies. On a single pair of mirror image dies, one closed loop shape could form a circle, a second a rectangle, a third a triangle, resulting in the consequent production of cards corresponding to these diverse shapes. Thus, multiple cards of many shapes and sizes can be produced simultaneously with each cycle of the press 1 and die set 2 illustrated in FIG. 1.

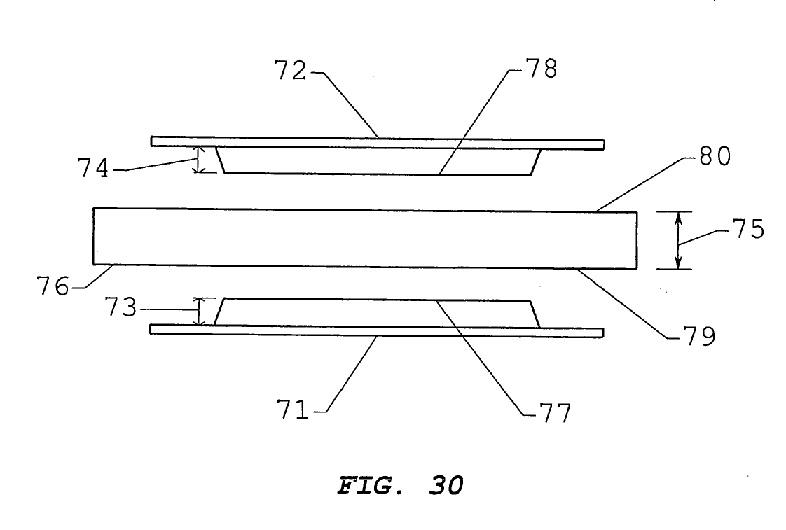

FIG. 30 illustrates a pair of cutting dies 71 and 72 having closed loop perimeter cutting edge apex heights 73 and 74 just slightly more than half the thickness 75 of material 76 from which articles will be formed. Cutting knife height controls the penetration depth of cutting rules 77 and 78. By regulating rule height on the opposed dies the cutting depth into surface 79 and surface 80 of the material is controlled.

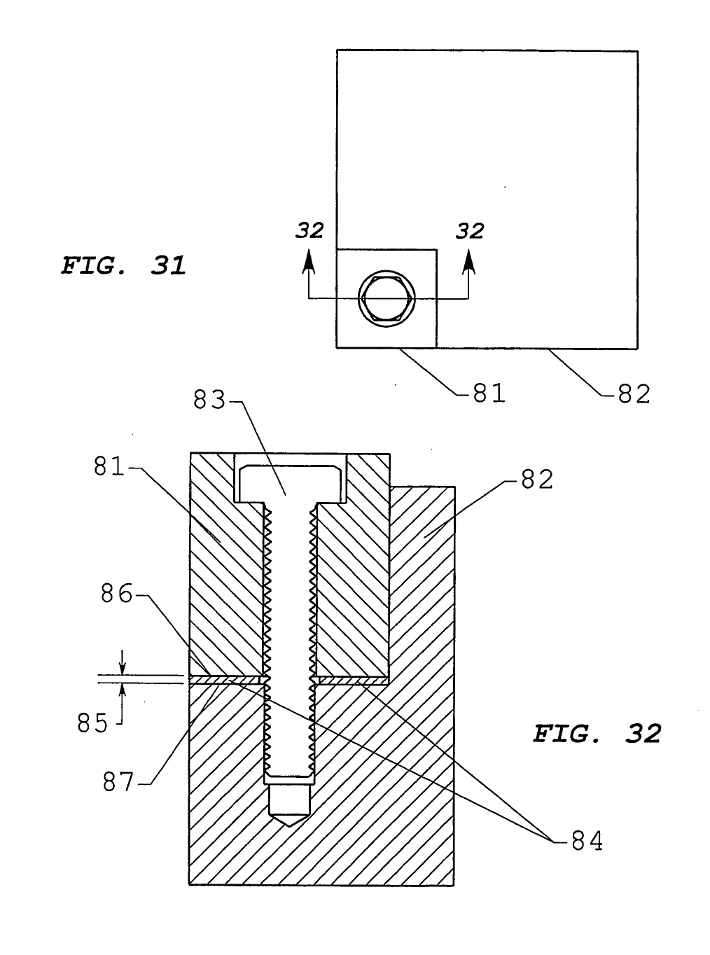

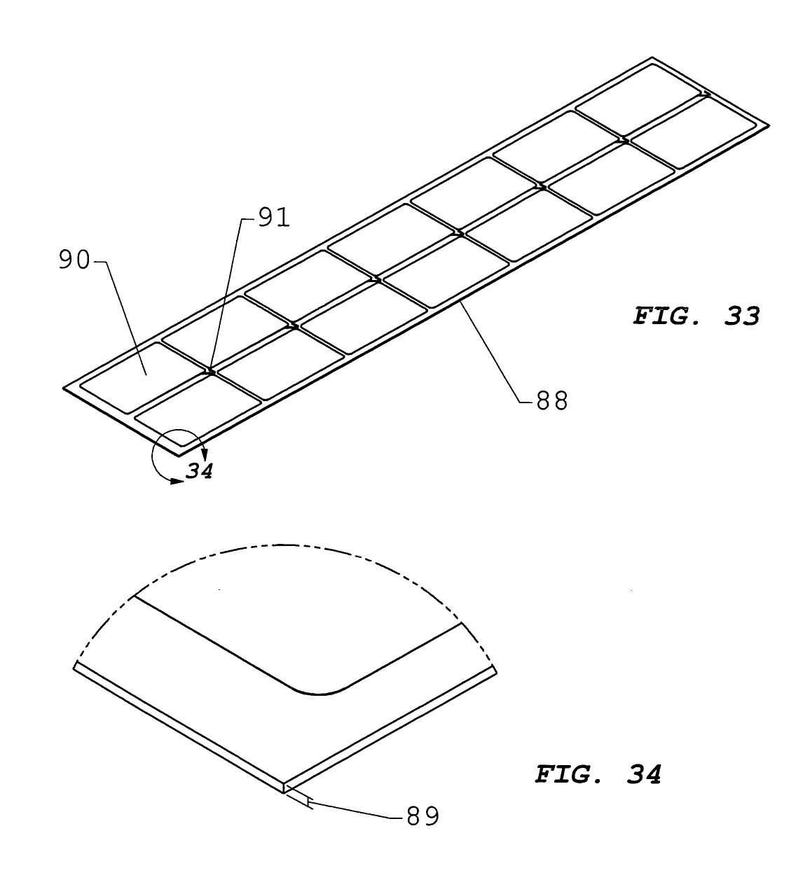

FIGS. 31 and 32 illustrate one of stop members 15, 16, 17 and 18 shown in FIG. 1, in an adjustable configuration. Stop 81, is held to a die shoe 82 by screw 83 with shim 84 having a thickness 85 in increments of less than 0.001 inch interposed between a surface 87 of the die shoe 82 and a surface 86 of the stop 81 to control the minimum separation therebetween in sub-0.001 inch increments.

FIGS. 33 and 34 illustrate a sheet of flat stock material 88 with thickness 89 between 0.007 inch and 0.0625 inch, decorated with a 2-across by a 7-up printed pattern 90 with corresponding registration mark 91.

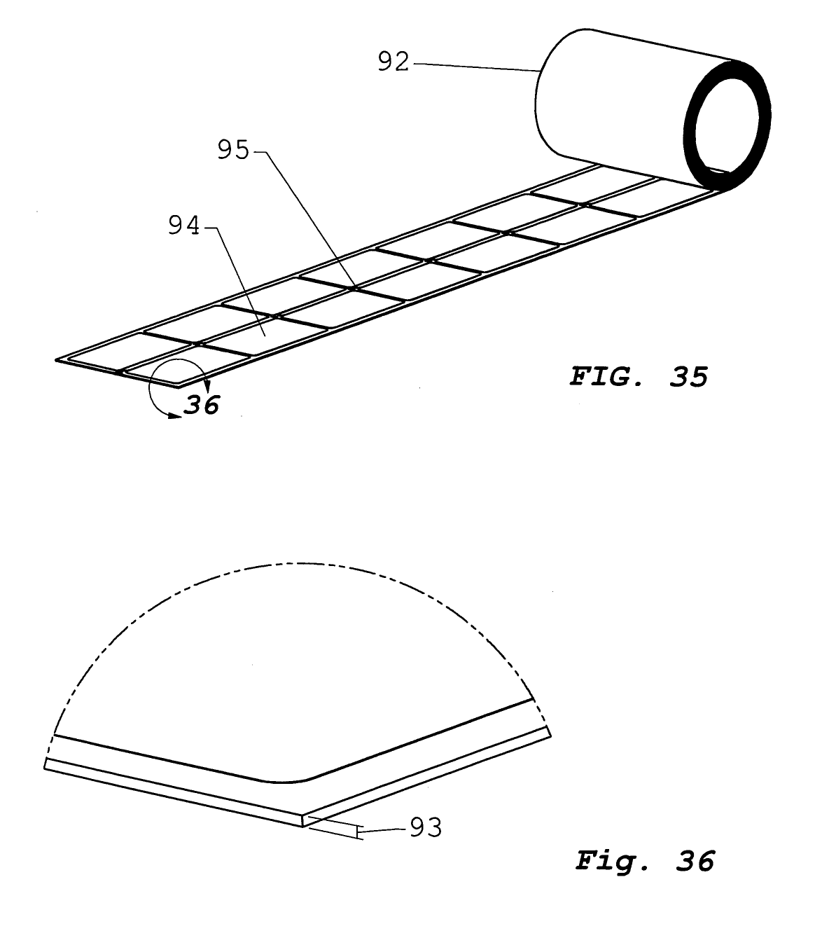

FIGS. 35 and 36 illustrate a roll of flat stock material 92 with a thickness 93 between 0.007 inch and 0.0625 inch, decorated with a 2-across printed pattern 94 with corresponding registration mark 95.

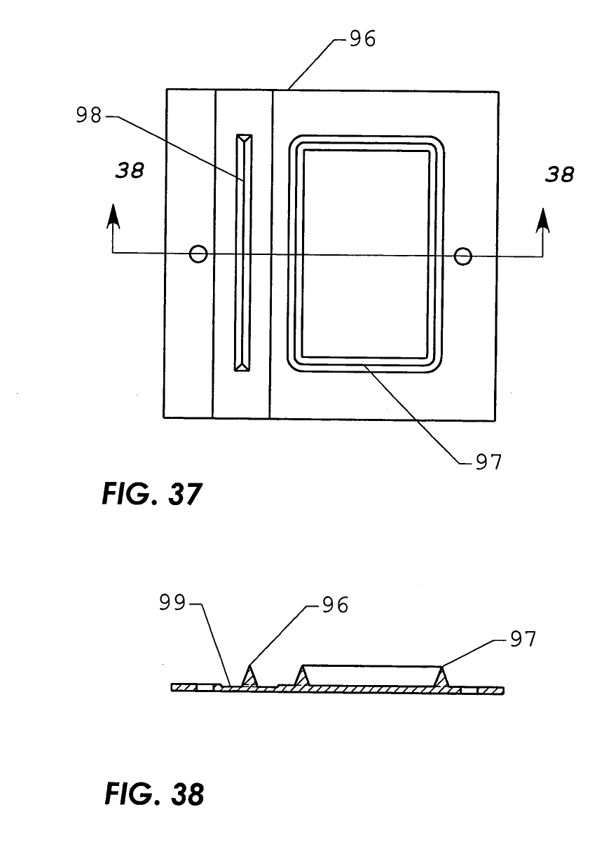

FIGS. 37 and 38 illustrate plan and sectional views of die 96 having a closed loop shape cutting configuration 97 and a non-closed loop configuration 98 outside the perimeter of closed-loop shape 97. Recessed surface 99 increases the vertex height of cutting edge configuration 98 to increase penetration depth of configuration 98 into flat stock.

FIG. 39 illustrates a profile of a cutting knife generally indicated by 109 formed of a double bevel shape. Sharp apex 110 is formed by angle 111. A double bevel is formed at points 112 and 113, which decreases the included angle between side 114 and 115 of the lower portion of the cutting knife.

FIG. 40 illustrates a sectional view of a cutting knife 116 formed of an asymmetrical shape. Angle 117 is different than angle 118.

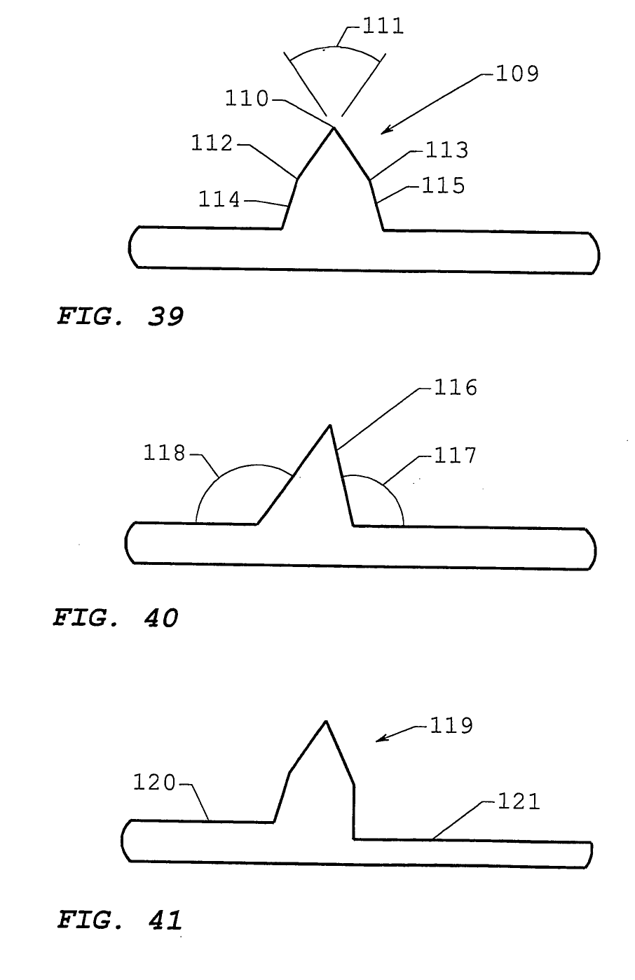

FIG. 41 illustrates a sectional view of a cutting knife generally indicated by 119 formed of an asymmetrical, multi-bevel shape and having sides of dissimilar height 120 and 121.

While the present invention has been described with reference to the above preferred embodiments, it will be understood by those skilled in the art that various changes may be made and equivalence may be substituted for elements thereof without departing from the scope of the present invention. In addition, modifications may be made to adapt a particular situation or material to the teachings of the present invention without departing from the scope of the present invention. Therefore, it is intended that the invention not be limited to the particular embodiments disclosed in carrying out this invention, but that the present invention includes all embodiments falling within the scope of the appended claims.

1. An Apparatus for making articles from flat stock material, wherein
a die set for reciprocal movement along an axis includes a first movable die holder and a second stationary die holder, said die holders having respective parallel, facing, flat surfaces for registering interchangeable flat dies thereon, at least one guide member to precisely control the spatial relationship of said first and second die holders, at least one stop member to control the minimum separation between said first and second die holders, comprising
at least one first die registered to said first die holder flat surface for predetermined movement along said axis, at least one configuration forming a loop upon said first die and having a sharp apex cutting edge facing said second die holder,
at least one second die registered to said second die holder flat surface, having
at least one opposed configuration having a defined apex cutting edge facing said first die holder, said opposed configuration forming a mirror image of said first die loop configuration and precisely aligned with said first die apex cutting edge,
said first die holder operable to move along said axis to said second die holder so that said first die loop apex cutting edge is spaced a predetermined distance from said second die loop apex cutting edge,
whereby said first apex Loop cutting edge and said second apex loop cutting edge are impressed with sufficient force and to sufficient depth into each respective side of a length of said flat stock material so as to fracture and cut therefrom an article substantially identical in contour to said loop configuration defined by said first and said second die loop apex cutting edges.

2. An apparatus as claimed in claim 1 comprising each said apex cutting edge sharpened to less than 0.005 inch.

3. An apparatus as claimed in claim 1 comprising said predetermined distance between said first and second die apexes of less than 0.005 inch.

4. An apparatus as claimed in claim 1 comprising stop members disposed upon at least one of said die holders for contact with the other of said die holders to adjustably control the minimum separation between said first and second die holders in increments of less than 0.001 inch.

5. An apparatus as claimed in claim 1 comprising at least one of said first and second die apex cutting edges of vertex height just slightly more than one half of a flat stock material thickness whereby penetration depth of said cutting edges into the sheet surfaces is controlled.

6-8. (canceled)

9. An apparatus as claimed in claim 1 comprising embossed flat stock material with a non-embossed thickness between 0.007 inch to 0.0625 inch thick.

10. An apparatus as claimed in claim 1 comprising said first die and second die apex cutting edges formed to a vertex height of between 0.005 and 0.060 inch.

11. An apparatus as claimed in claim 1 comprising said first die and second die apex cutting edges formed by etching.

12. An apparatus as claimed in claim 1 comprising said first and second die apex cutting edges formed by machining.

13. An apparatus as claimed in claim 1 comprising said first die and second die apex cutting edges formed by etching and machining.

14. An apparatus as claimed in claim 1 comprising said first and second die apex cutting edges formed by welding and machining.

15-20. (canceled)

21-40. (canceled)

41. (canceled)

42. An apparatus for making articles from flat stock material, wherein
a die set for reciprocal movement along an axis includes a first movable die holder and a second stationary die holder,
said die holders having respective parallel, facing flat surfaces for registering and holding interchangeable flat dies thereon,
at least one guide to precisely control the spatial relationship of said first and second die holders,
at least one stop member to control the minimum separation between said first and second die holders, comprising
at least one first die registered to said first die holder flat surface for predetermined movement along said axis, at least one configuration forming a loop upon said first die and having a sharp apex cutting edge facing said second die holder,
at least one second die registered to said second die holder flat surface, at least one opposed configuration having a sharp defined apex cutting edge facing said first die holder, said opposed configurations for ng a mirror image of said first die loop configuration and precisely aligned with said first die cutting edge,
said first die holder operable to move along said axis to said second die holder so that said first die loop apex cutting edge is spaced a predetermined distance from said second die loop apex cutting edge,
at least one internal configuration disposed within at least one loop of one of said first and second die loop configurations having a sharp cutting edge,
whereby said first apex loop cutting edge and said second loop apex cutting edge are impressed with sufficient force and to sufficient depth into each respective side of a length of said flat stock material so as to fracture and cut therefrom an article substantially identical in contour to said loop configuration defined by said first and said second die loop apex cutting edges, and
whereby said internal configuration apex cutting edge is impressed into at least one side of said length of flat stock material to cut at least a score line into said material and thereby weaken the material sufficiently for subsequent breaking apart at said score line.
